(19) United States
(12) Patent Application Publication
(10) Pub. No.: US 2007/0141875 A1
(43) Pub. Date: Jun. 21, 2007

(54) Multi-level directory

(76) Inventor: Brian K. Daigle, Marietta, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/304,289

(22) Filed: Dec. 15, 2005

(51) Int. Cl. H01R 25/00

(52) U.S. Cl. 439/115

(57) ABSTRACT

Described is a method for providing contact information to a user. At least one embodiment of the method includes determining at least one direct contact of the user, where the at least one direct contact is associated with contact information and determining presence information related to the at least one direct contact of the user. At least one additional embodiment includes determining at least one indirect contact of the user and facilitating display of at least a portion of the contact information associated with the at least one indirect contact. Other methods and devices are provided.

### BACKGROUND

With the advent of the Internet, different forms of digital communications have recently appeared. Examples of such digital communications include email, Internet telephony, and instant messaging (IM). Often, in instant messaging, a first user communicates with a second user in near real time. Unlike email messages, which reside on a server or a client until deleted, IM messages typically vanish when an IM chat session is terminated, unless that instant messaging chat session is recorded in an instant messaging chat transcript.

Currently, techniques exist that allow a user to save information related to contacts (e.g., persons to whom the user communicates) to an address book or a buddy list. While the address book can be beneficial to the user in that the address book can provide quick and effective avenues for initiating communications with another user, these address books can have drawbacks. More specifically, many users do not have contact information for everyone with whom they wish to communicate. Contact information related to a user's acquaintances may be unavailable to the user for any of a plurality of reasons. Additionally, many users limit the number of contacts in their address book because huge numbers of contacts makes it difficult to locate any one contact. Further, storing large amounts of data on a client device can reduce performance of the client device.

Thus, a heretofore unaddressed need exists in the industry to address the aforementioned deficiencies and inadequacies.

### SUMMARY

Embodiments of the present disclosure include a method for providing contact information to a user. Embodiments of the method include determining at least one direct contact of the user, wherein the at least one direct contact is associated with contact information. Additionally, embodiments include determining presence information related to the at least one direct contact of the user and in response to determining presence information related to the at least one direct contact of the user, determining at least one indirect contact of the user. At least one other embodiment includes facilitating display of at least a portion of the contact information associated with the at least one indirect contact.

Additionally included herein are embodiments of a computer readable medium that includes a program for providing contact information to a user. Embodiments of the program include logic configured to determine at least one direct contact of the user, where the at least one direct contact is associated with contact information and logic configured to determine presence information related to the at least one direct contact of the user. Additional embodiments include logic configured to, in response to determining presence information related to the at least one direct contact of the user, determine at least one indirect contact of the user. Additionally, embodiments of the program include logic configured to facilitate display at least a portion of the contact information associated with the at least one indirect contact.

Other systems, methods, features, and advantages of this disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

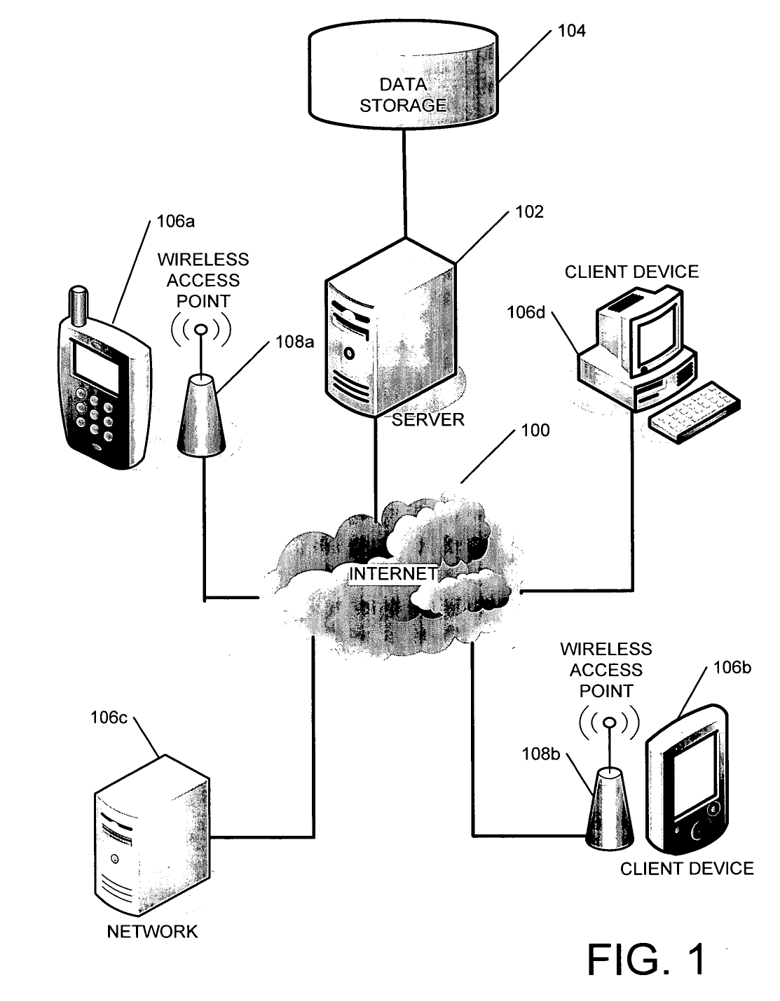

FIG. 1 is a functional diagram of an exemplary communications environment.

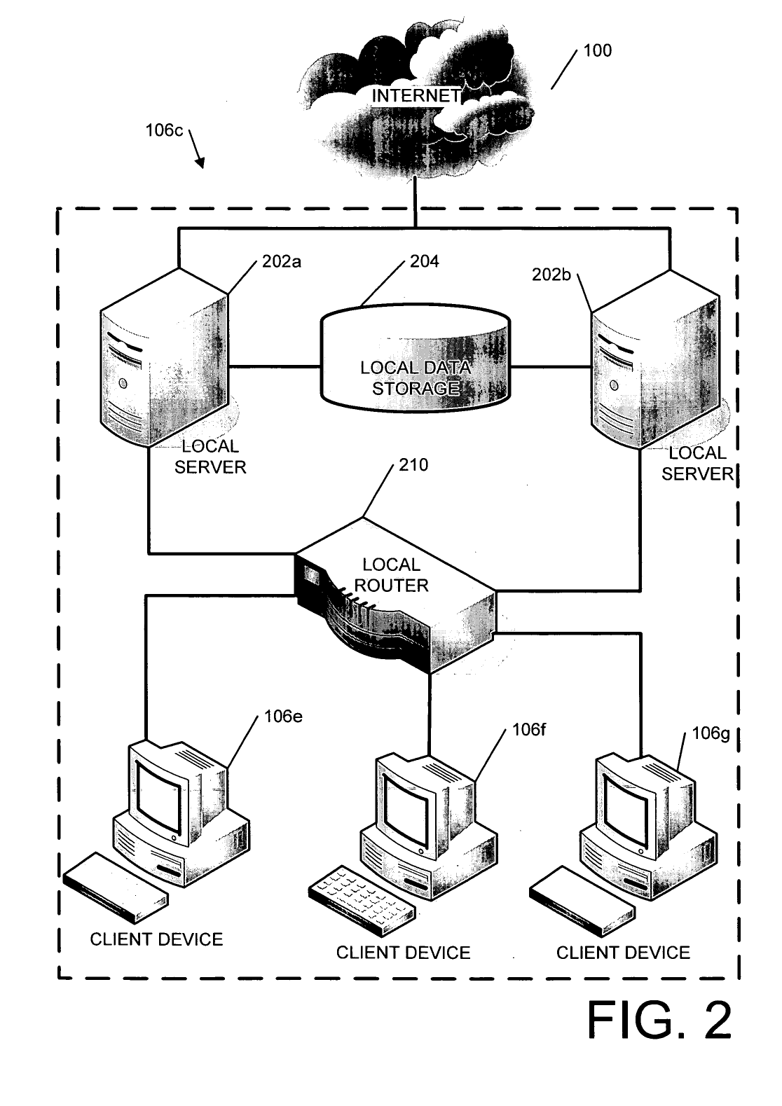

FIG. 2 is a functional diagram of an exemplary local network environment by which a user can communicate, similar to the environment from FIG. 1.

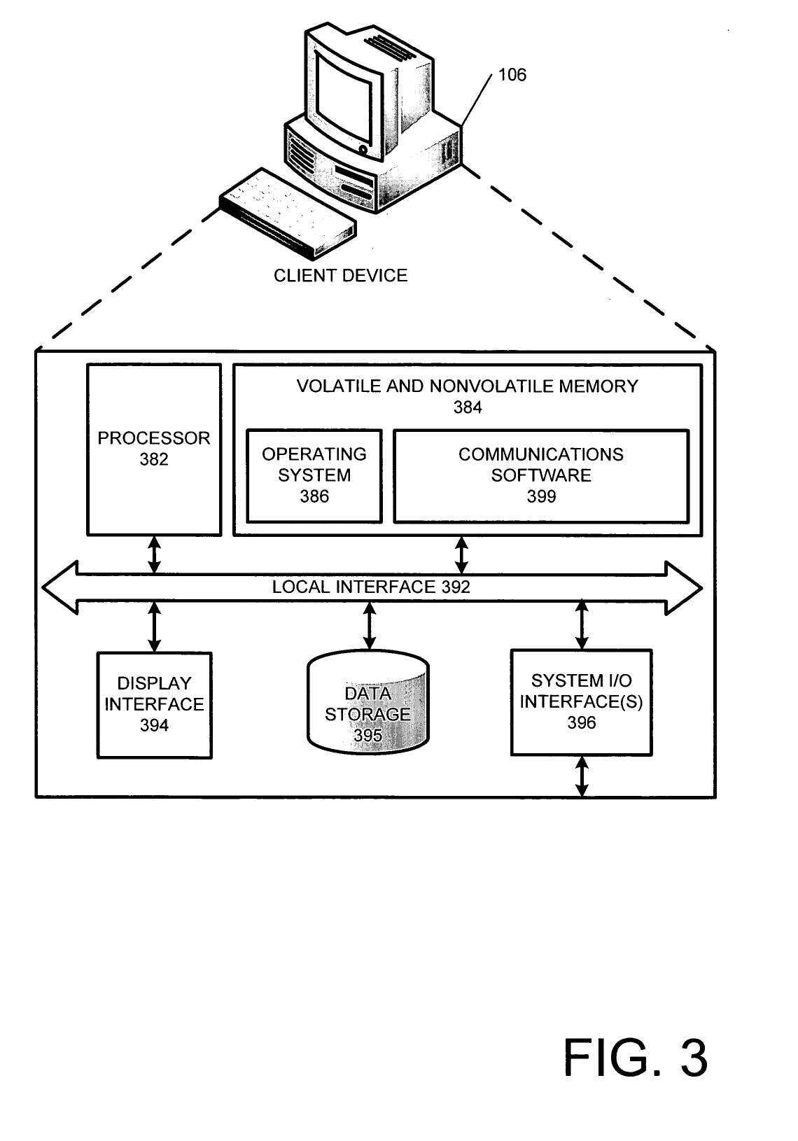

FIG. 3 is a functional diagram illustrating an exemplary embodiment of a client device that may be configured to communicate via a communications network such as the networks from FIGS. 1 and 2.

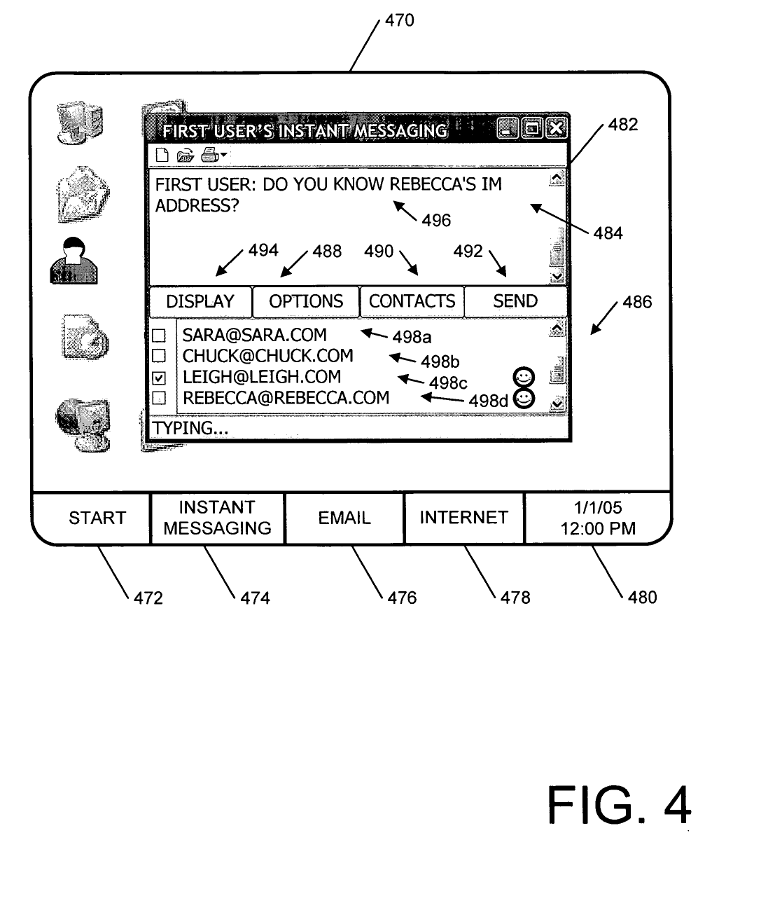

FIG. 4 is an exemplary display for the instant messaging client software, discussed with reference to FIG. 3.

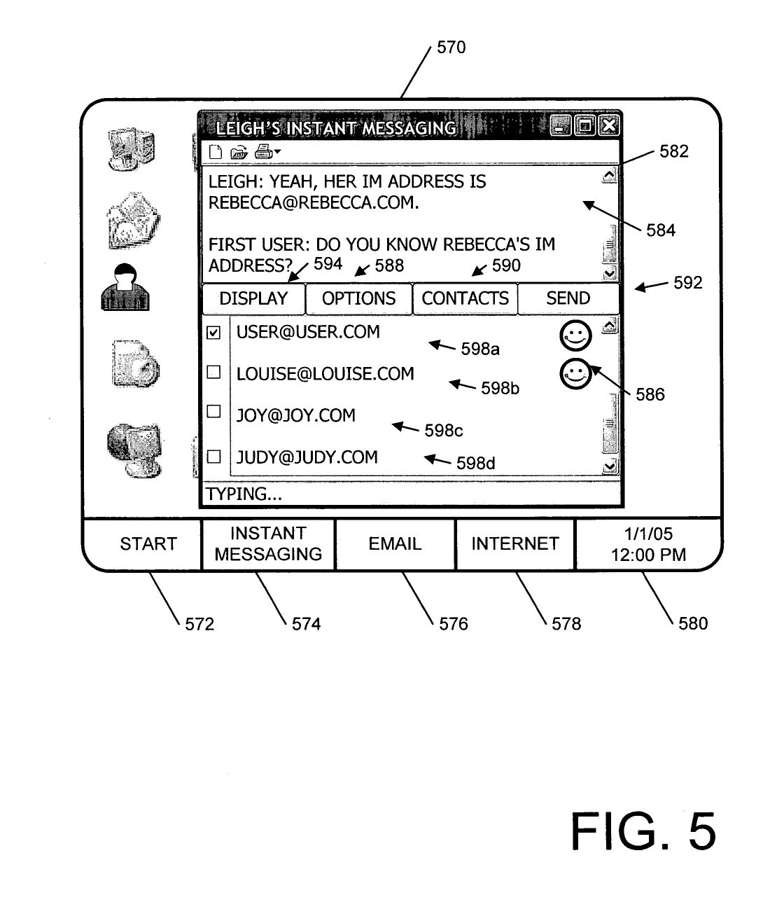

FIG. 5 is an exemplary display for the communications software that has been deselected by the user activating another program, as in an instant messaging environment such as discussed with reference to FIGS. 1 and 2.

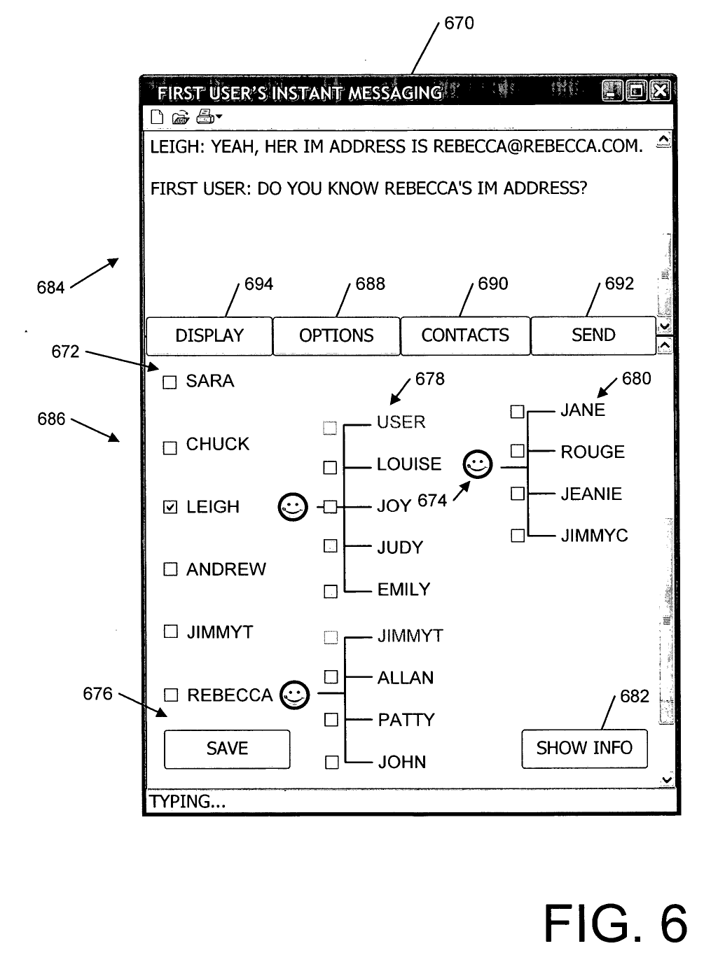

FIG. 6 is a display of an exemplary instant messaging window, illustrating contacts from a plurality of sources, similar to the configurations from FIGS. 4 and 5.

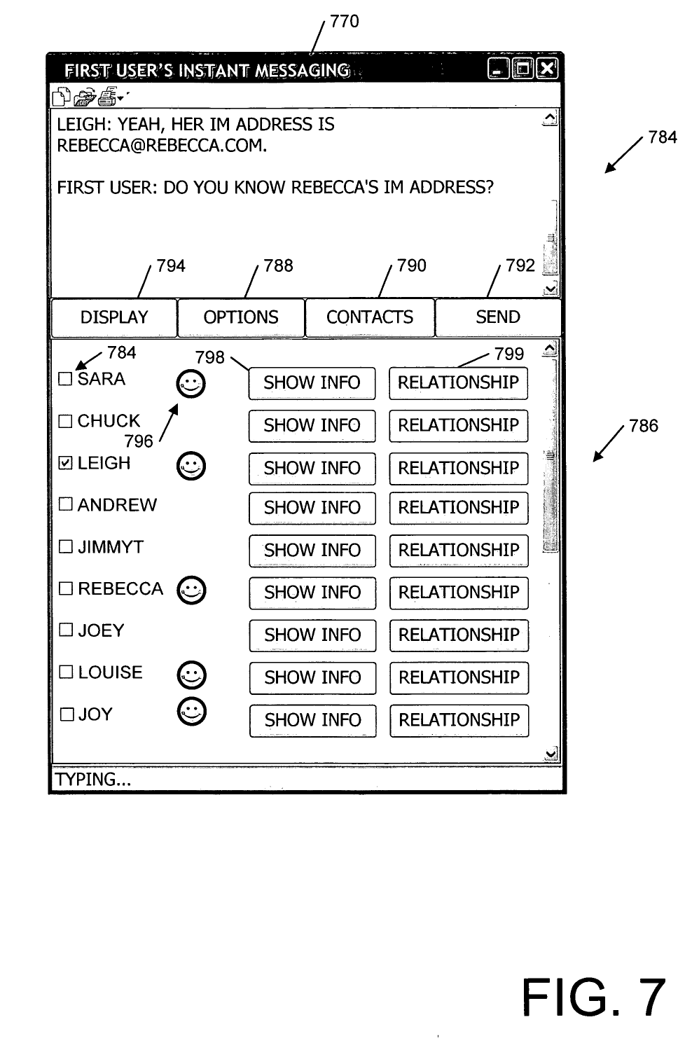

FIG. 7 is a display of an exemplary instant messaging window, illustrating contacts from a plurality of sources, similar to the configuration from FIG. 6.

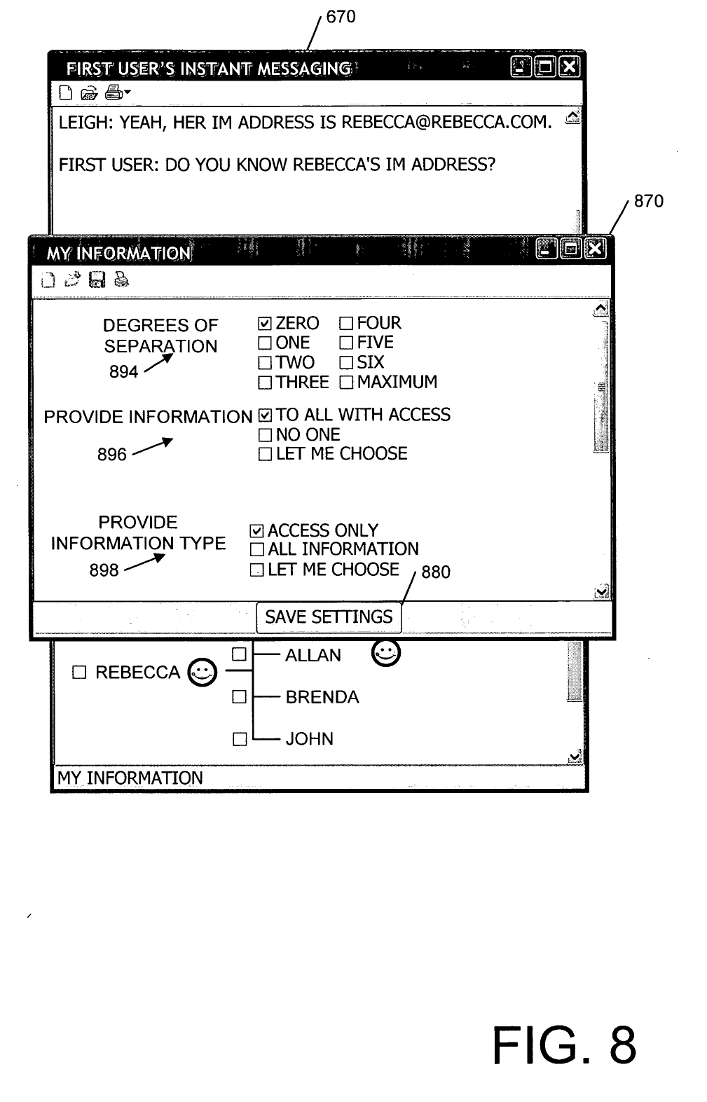

FIG. 8 is a display of an exemplary options window for providing a user with the ability to determine how his or her information is displayed to other users, similar to the display of FIG. 6.

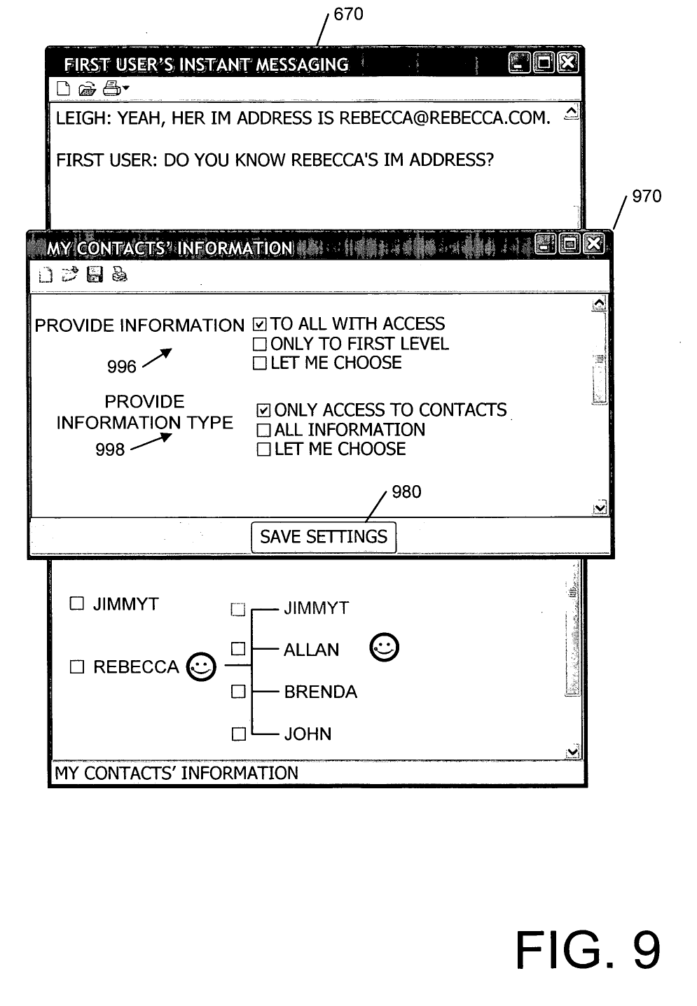

FIG. 9 is a display of an exemplary interface to a “my contacts' information” option that can be provided to a user of the instant messaging software from FIG. 6.

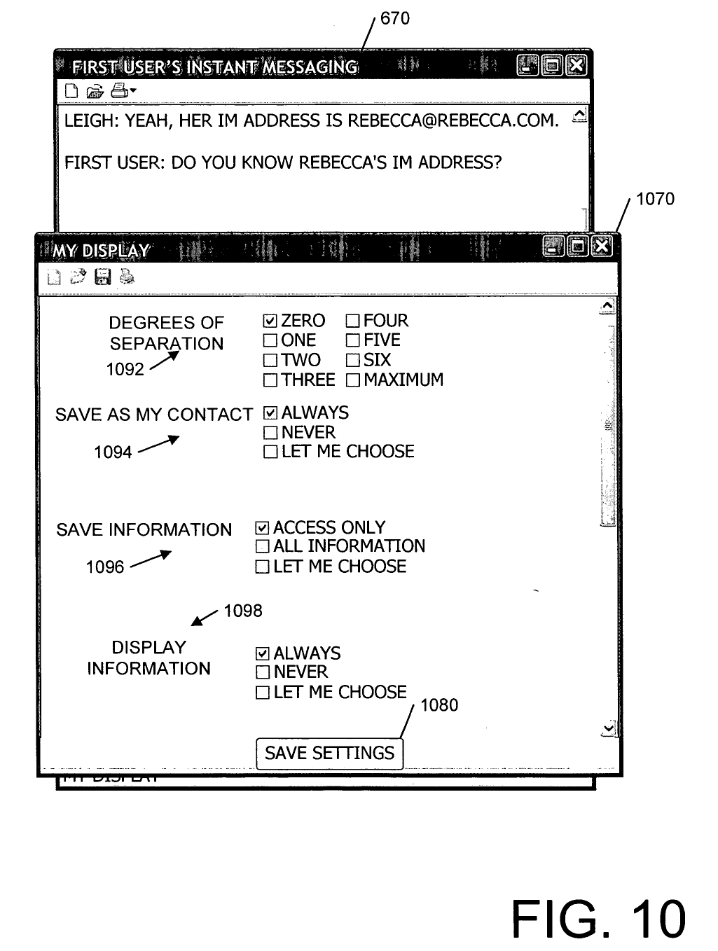

FIG. 10 is a display of an exemplary interface to a “my display” option that a can be provided to a user, from the instant messaging window from FIG. 6.

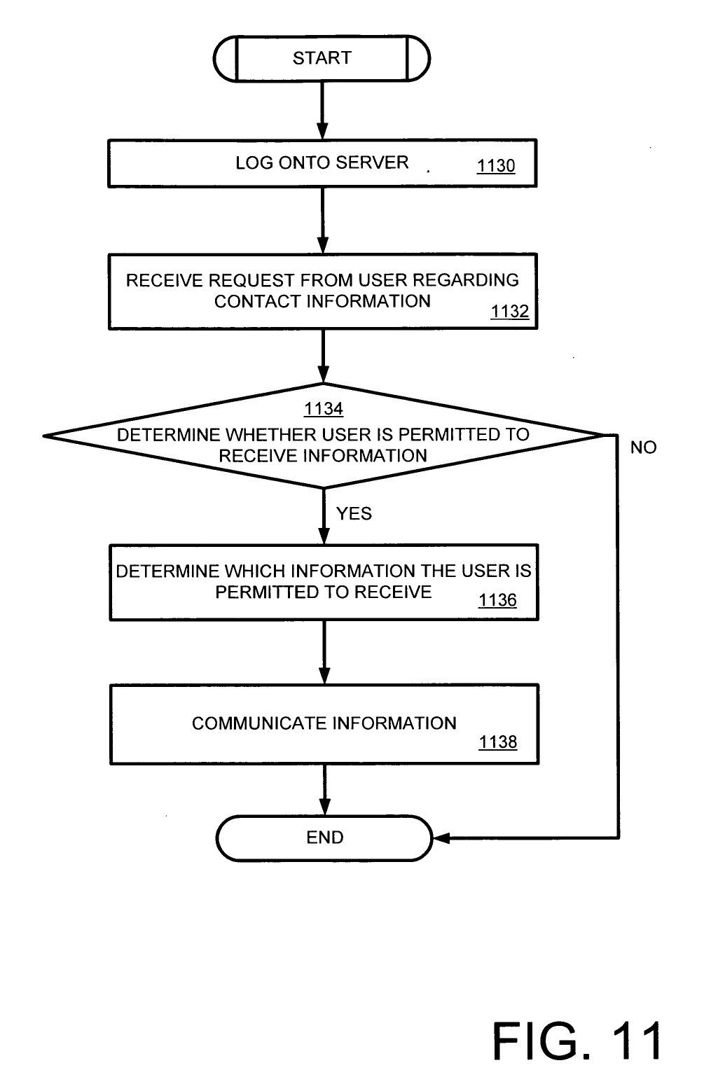

FIG. 11 is a flowchart illustrating exemplary steps that can be taken in providing contact information related to a user in a communications environment, such as the environment from FIG. 1.

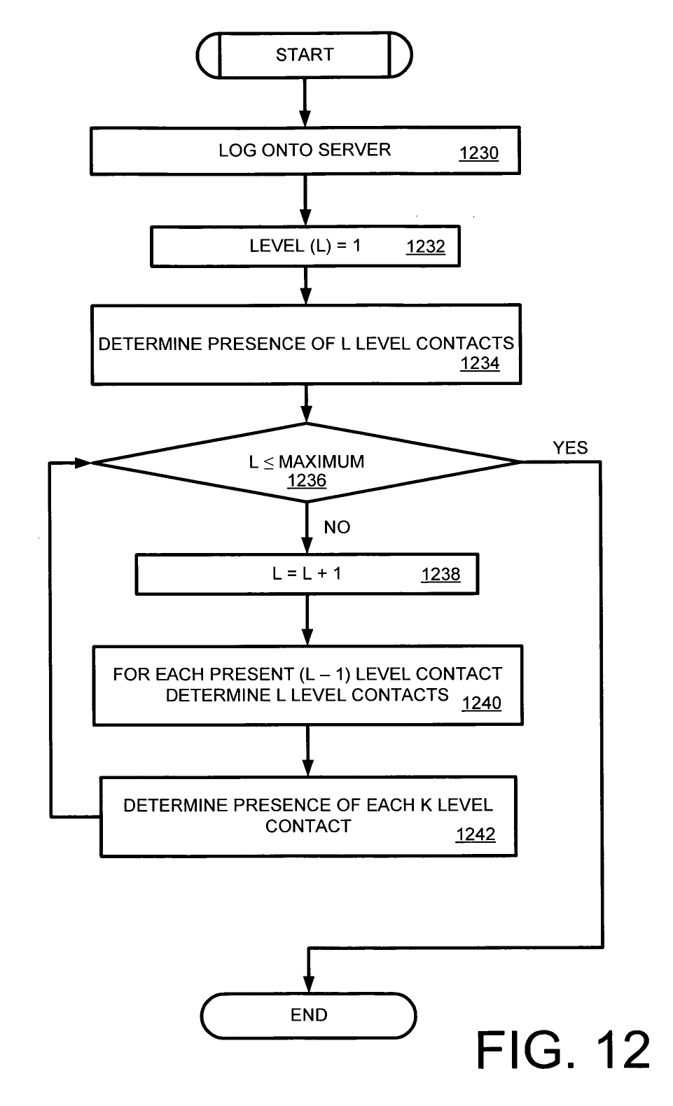

FIG. 12 is a flowchart illustrating exemplary steps that can be taken in determining information displayed in a communications environment, such as the communications environment from FIG. 1.

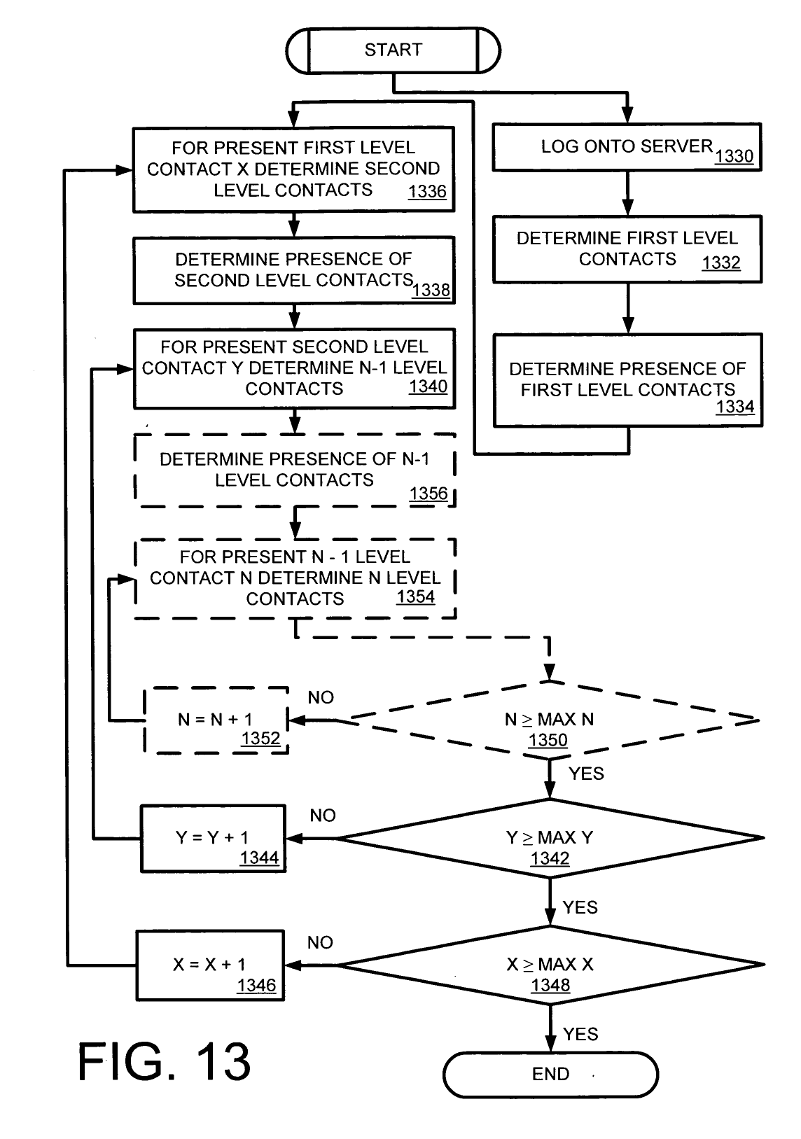

FIG. 13 is flowchart illustrating exemplary steps that can be taken to determine multi-level contacts, similar to the flowchart from FIG. 12.

### DETAILED DESCRIPTION

FIG. 1 is a functional diagram of an exemplary communications network environment. As illustrated, a plurality of users may be connected via an external network such as Internet 100 or other communications network. The users may access the Internet 100 via client devices 106a (via wireless access point 108a), 106b (via wireless access point 108b), 106c, and 106d. The client devices may include, for example, portable communication devices 106a and 106b, a local network 106c and/or a personal computer 106d. It should be appreciated that the external network, client devices and connections illustrated in FIG. 1 are shown by way of example, but this disclosure is not limited to these examples. The disclosure may be applicable to any client device, connection, and external network that supports instant messaging. Additionally included in this nonlimiting example is a server 102 that is coupled to data storage 104.

During an instant messaging session, a user may activate instant messaging, email, Voice Over Internet Protocol, or other communications software. Activation of the communications software can facilitate a connection request with the server 102, which may be a dedicated instant messaging server. The server 102 can then authenticate the user via any of a variety of different authentication techniques including, but not limited to technologies related to a user identification (userid) and password (userpw) and various biometric authentication processes. Generally speaking, the authentication process includes the server receiving the requested data (such as a userid and userpw) and comparing that data with data stored on data storage device 104 (or data storage logic). If the data submitted by the user matches the data stored in data storage 104, the user can be authenticated.

Once the user has been authenticated, the user can send an instant message to any of his or her contacts (e.g., other parties that communicate with the user). Generally speaking, the user can send an instant message to anyone who has an account with the server 102. If the user knows the desired recipient's account name, handle, or instant message identification (IMID) associated with the server 102, the user can send an instant message to that recipient. In many circumstances, the user will have the user's contacts saved on instant messaging client software or on the server 102 such that the user does not have to re-enter the account name each time the user wishes to send an instant message.

Additionally, the server 102 can keep track of users that are currently logged onto the server 102, and provide presence information regarding these users. The presence information can include information related to one or more accounts associated with that user. As a nonlimiting example, a user may have multiple email accounts, multiple instant messaging accounts, etc. In at least one embodiment, presence information related to each account. Similar presence information related to a client device may also be determined. Thus, if a user wishes to communicate with a contact, the server 102 can send presence information regarding whether that contact is currently logged onto the server 102. Upon receiving the presence data related to the user's contacts, the user can then send a communication or communication request to a recipient contact (whose presence is determined), thereby beginning a communication session.

In at least one networking environment, each message sent between the user and the contact can be communicated through the server 102. In such a scenario, the user at client device 106a can create and send a message that is directed from the user's client device 106a to the wireless access point 108a, and then to the Internet 100. The message can then be sent to the server 102 back through the Internet 100 to the recipient's client device 106b.

While one or more networking environments may work this way, others may work without the messages being communicated through the server 102. Additionally, some communications environments may have a dedicated server (or servers) while others may use devices (such as servers) that can manage various tasks.

FIG. 2 is a functional diagram of an exemplary local network environment by which a user can communicate with another user, similar to the environment from FIG. 1. The local network environment of FIG. 2 can be a home network, a business network or other network configured to facilitate communication between users. As illustrated, client devices 106e, 106f, 106g are coupled to a local router 210. This coupling may be wire-line or wireless. Though depicted as personal computers, the client devices 106e, 106f, and 106g may be implemented with any device capable of supporting instant messaging in a local network. The local router is coupled to local server 202a and local server 202b. The local servers 202a, 202b (collectively referred to as local server 202) are coupled to local data storage 204. The local servers 202 are also coupled to an external network, such as the Internet 100.

In this exemplary networking environment a user located at client device 106e may desire to communicate with a recipient located at client device 106g. In the networking environment of FIG. 2, the user at client device 106e can compose and send a message via client software stored on the client device 106e. The message can then be sent from the client device 106e to the local router 210. The local router can then send the message to one of the local servers 202. The local server 202 can then communicate the message back through the local router 210 to the intended recipient located at client device 106g.

As the nonlimiting example of FIG. 2 illustrates, messages can be sent internal to the local network, without the user of an external network, such as the Internet 100. Additionally, while the configuration of FIG. 2 facilitates intra-network communications, such a configuration could also facilitate inter-network communications, similar to the configuration from FIG. 1. In such a scenario, a user operating client device 106f can send messages to and receive messages from a contact that is not located within the local network of FIG. 2 via client device 106f. The messages can be sent through local router 210 to local server 202. From local server 202, the message can be sent to an external network, such as the Internet 100.

Referring back to FIG. 1, the message can then be sent from the network 106c to server 102, and then back through the Internet 100 to client device 106b. The contact that is operating client device 106b can then reply through the same channels. More specifically, the reply message can be sent from 106b through the Internet 100 to the server 102, back through the Internet 100, to the network 106c (to FIG. 2), to the local server 202, through the local router 210, and back to the user at client device 106f.

One should note that the configuration of FIG. 2 is a nonlimiting example. Components can be added or removed (or both) without diverging from the scope of this disclosure. Additionally, although the configurations from FIGS. 1 and 2 are illustrated as various examples of a configuration conducive to email or instant messaging, these are also not meant to be limiting. More specifically, a public switched telephone network (PSTN) can also be included, as well as dedicated servers for email, instant messaging, Internet telephony etc.

Additionally, while some communications may use the Internet 100, others do not. More specifically, two users that are engaged in an communications session on the same Internet Service Provider (ISP) may not require the use of the Internet 100 to facilitate the communication. As the ISP can link a user to the Internet 100, two users operating on the same ISP may simply use the ISP to facilitate the communication. In such a scenario, the configuration of FIG. 2 becomes more applicable, even for users who are not otherwise related. Additionally, if a company has multiple offices, use of the Internet 100 for communications may be desired.

FIG. 3 is a functional diagram illustrating an exemplary embodiment of a client device that may be configured to communicate via a communications network such as the networks from FIGS. 1 and 2. Although a wire-line client device is illustrated, this discussion can be applied to any device including, but not limited to a mobile telephone, a portable telephone a wireless personal computer, a wire-line personal computer, a PDA, a blackberry, an IPOD, and any other device configured for communications. Generally, in terms of hardware architecture, as shown in FIG. 3, the client device 106 includes a processor 382, volatile and nonvolatile memory 384, a display interface 394, data storage 395, and one or more input and/or output (I/O) device interface(s) 396 that are communicatively coupled via a local interface 392. The local interface 392 can include, for example but not limited to, one or more buses or other wired or wireless connections. The local interface 392 may have additional elements, which are omitted for simplicity, such as controllers, buffers (caches), drivers, repeaters, and receivers to enable communications. Further, the local interface may include address, control, and/or data connections to enable appropriate communications among the aforementioned components. The processor 382 may be a hardware device for executing software, particularly software stored in volatile and nonvolatile memory 384.

The processor 382 can be any custom made or commercially available processor, a central processing unit (CPU), an auxiliary processor among several processors associated with the client device 106, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard® Company, an 80x86 or Pentium® series microprocessor from Intel® Corporation, a PowerPC® microprocessor from IBM®, a Sparc® microprocessor from Sun Microsystems®, Inc, or a 68xxx series microprocessor from Motorola® Corporation.

The volatile and nonvolatile memory 384 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 384 may incorporate electronic, magnetic, optical, and/or other types of storage media. Note that the volatile and nonvolatile memory 384 can have a distributed architecture, where various components are situated remote from one another, but can be accessed by the processor 382. Additionally volatile and nonvolatile memory 384 can include communications software 399 and an operating system 386.

The software in volatile and nonvolatile memory 384 may include one or more separate programs, each of which includes an ordered listing of executable instructions for implementing logical functions. In the example of FIG. 3, the software in the volatile and nonvolatile memory 384 may include communications software 399 (which can include instant messaging software, email software, Internet telephony software, etc. in one or more separate software packages), as well as operating system 386. A nonexhaustive list of examples of suitable commercially available operating systems is as follows: (a) a Windows® operating system available from Microsoft® Corporation; (b) a Netware® operating system available from Novell®, Inc.; (c) a Macintosh® operating system available from Apple® Computer, Inc.; (d) a UNIX operating system, which is available for purchase from many vendors, such as the Hewlett-Packard® Company, Sun Microsystems®, Inc., and AT&T® Corporation; (e) a LINUX operating system, which is freeware that is readily available on the Internet 100; (f) a run time Vxworks® operating system from WindRiver® Systems, Inc.; or (g) an appliance-based operating system, such as that implemented in handheld computers or personal data assistants (PDAs) (e.g., PalmOS® available from Palm® Computing, Inc., and Windows CE® available from Microsoft® Corporation). The operating system 386 essentially controls the execution of other computer programs and provides scheduling, input-output control, file and data management, memory management, and communication control and related services.

A system component embodied as software may also be construed as a source program, executable program (object code), script, or any other entity comprising a set of instructions to be performed. When constructed as a source program, the program is translated via a compiler, assembler, interpreter, or the like, which may or may not be included within the volatile and nonvolatile memory 384, so as to operate properly in connection with the Operating System 386.

The Input/Output devices that may be coupled to system I/O Interface(s) 396 may include input devices, for example but not limited to, a keyboard, mouse, scanner, microphone, etc. Further, the Input/Output devices may also include output devices, for example but not limited to, a printer, display, speaker, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

If the client device 106 is a personal computer, workstation, or the like, the software in the volatile and nonvolatile memory 384 may further include a basic input output system (BIOS) (omitted for simplicity). The BIOS is a set of software routines that initialize and test hardware at startup, start the Operating System 386, and support the transfer of data among the hardware devices. The BIOS is stored in ROM so that the BIOS can be executed when the client device 106 is activated.

When the client device 106 is in operation, the processor 382 is configured to execute software stored within the volatile and nonvolatile memory 384, to communicate data to and from the volatile and nonvolatile memory 384, and to generally control operations of the client device 106 pursuant to the software. Software in memory, in whole or in part, are read by the processor 382, perhaps buffered within the processor 382, and then executed.

FIG. 4 is an exemplary display for a first user's communications software, discussed with reference to FIG. 3. As illustrated, the desktop display 470 can include a “START” option 472, an “INSTANT MESSAGING” taskbar menu item 474, an “EMAIL” taskbar menu item 476, an “INTERNET” taskbar menu item 478, and a Date and Time indicator 480. As one of ordinary skill in the art will understand, the taskbar menu items can be linked to various software programs that are currently running on the client device 106. As a nonlimiting example, communications software 399, which can display instant messaging window 482 relates to the taskbar menu item 474. By selecting the “INSTANT MESSAGING” taskbar menu item 474, the first user can display and remove the instant messaging window 482 from the desktop display 470.

As illustrated, the instant messaging window 482 includes an input box 484 for the user to send and receive messages to and from another user. The input box 484 can be configured to display both outgoing messages and incoming messages. As such, a history (thread) of the current instant messaging session can be documented. The input box 484 currently includes an instant message composed by the user for “Leigh.” This message can also be sent to others by selecting the appropriate checkbox next to the desired contact in the contact section 486 of the instant messaging window 482. Additionally present in contact section 486 are contacts, denoted 496a-496d and a presence icon associated with each contact who is currently logged onto server 102. As discussed above, the server 102 can determine which users are currently logged onto the server 102 and can display this information to other parties. In this nonlimiting example, the contact “Leigh” 496c is currently logged onto the server (via one or more accounts), while the contacts “Sara” 496a, “Chuck” 496b, and “Andrew” 496d are not logged onto the server. One should note that while the first user has access to the contacts listed in contact section 486, generally speaking, the first user does not have access to parties not listed in contact section 486.

Additionally included in the instant messaging window 482 are a “DISPLAY” option 494, an “OPTIONS” option 488, a “CONTACTS” option 490, and a “SEND” option 492. The “DISPLAY” option 494 can provide the first user with various options related to the display of the first user's instant messaging window. The “OPTIONS” option 488 can provide the first user with access to various options related to the first user's communications software, as discussed in more detail below. The “CONTACTS” option, on the other hand, can provide the first user with various options related to the first user's contacts. The “SEND” option 492 is an action button that executes the operation of sending a message to the desired recipient or recipients.

One should note that the communications software 399, which can be configured to display the user interface of FIG. 4, is included for purposes of illustration, not limitation. As is evident to one of ordinary skill in the art, any communications logic can be used to facilitate communication between two parties. While the description with respect to FIG. 4 is directed to an instant messaging scenario, email, Internet telephony, and other types of communications can also apply.

FIG. 5 is an exemplary display for a second user's communications software discussed with reference to FIG. 3. Similar to the configuration of FIG. 4, the desktop display 570 can include a “START” option 572, an “INSTANT MESSAGING” taskbar menu item 574, an “EMAIL” taskbar menu item 576, an “INTERNET” taskbar menu item 578, and a Date and Time indicator 580. By selecting the “INSTANT MESSAGING” taskbar menu item 574, the second user (“Leigh”) can display and remove the instant messaging window 582 from the desktop display 570.

Additionally, the instant messaging window 582 includes an input box 584 Leigh uses to enter a message for other parties. Currently, the input box 584 includes the message 496 composed by the Leigh and a reply message 596 received from the first user. As described above, messages to other users can be created by selecting the appropriate checkbox, next to the desired party (or parties) in the contact section 586 of the instant messaging window 582. Additionally present in contact section 586 is a presence icon associated with each contact. More specifically, the contacts “First User” 596a and “Louise” 596b, are currently present. Contacts “Joy” 596c and “Judy” 596d are currently not present.

One should note that while first user (FIG. 4) and Leigh (FIG. 5) may have similar contacts, some of Leigh's contacts are generally not available to the first user. Additionally, some of first user's contacts are generally not available to Leigh. While the first user may not know all of Leigh's contacts, first user may still desire access to their contact information because of the common connection with Leigh.

Also included in the instant messaging window 582 are a “DISPLAY” option 594, an “OPTIONS” option 588, a “CONTACTS” option 590, and a “SEND” option 592. The “DISPLAY” option 594 can provide Leigh with various options related to the display of Leigh's instant messaging window. The “OPTIONS” option 588 can provide Leigh with access to various options related to Leigh's communications software, as discussed in more detail below. The “CONTACTS” option 590, on the other hand, can provide Leigh with various options related to Leigh's contacts. The “SEND” option 592 is an action button that executes sending of a message to the desired recipient or recipients.

One should note that the interface to communications software 399 displayed in FIG. 5 is included for purposes of illustration, not limitation. As is evident to one of ordinary skill in the art, any communications logic can be used to facilitate communication between two parties. As a nonlimiting example, email logic, Internet telephony logic, or other communications logic (or any permutation thereof) can be substituted for or supplemented with the instant messaging logic discussed with respect to FIG. 5.

FIG. 6 is a display of an exemplary instant messaging window, illustrating contacts from a plurality of sources, similar to the configurations from FIGS. 4 and 5. More specifically, instant messaging window 670 includes an input prompt 684, and a plurality of options that include “DISPLAY” option 694, “OPTIONS” option 688, “CONTACTS” option 690, and “SEND” option 692.

Also included in instant messaging window 670 is a multi-level directory contact window 686. The multi level directory contact window 686 includes the first user's first level “lower” contacts 672, which include “Sara,” “Chuck,” “Leigh,” “Andrew,” “JimmyT,” and “Rebecca.” Additionally included are presence icons 674 associated with each contact that is currently logged onto server 102. One should note that the first level “lower” contacts 672 include those contacts listed in FIG. 4. One should also note that for purposes of this disclosure, the term “lower contacts” refers to those parties who are a contact of the first user. Additionally, the term “upper contacts” refers to those parties who list the first user as a contact. More specifically, in FIG. 6, “Joy” is a lower contact of “Leigh” while “first user” is an upper contact of “Leigh.” Additionally both upper and lower contacts can include one or more levels, depending on the relationship with that particular party.

Second level lower contacts 678 include contacts of the user's first level lower contacts. More specifically, “User,” “Louise,” “Joy,” “Judy,” and “Emily” are lower contacts of “Leigh.” Additionally, “JimmyT,” “Allan,” “Patty,” and “John” are lower contacts of the first user's lower contact “Rebecca.” One should note that second level lower contact “JimmyT” has been disabled because “JimmyT” is also a first level lower contact of the first user. While FIG. 7 illustrates an embodiment that includes disabling redundant contacts, this is a nonlimiting example, and not a requirement of this disclosure. Additionally, second level lower contact “First User” is also disabled. As one of ordinary skill in the art will understand, as the first user generally does not need his or her own contact information, “First User” can be disabled from use as a second level lower contact. Similarly, other embodiments can simply refrain from displaying “First User” as a contact at all.

Third level lower contacts 680 include those users who are contacts of second level lower contacts 678. More specifically, second level lower contacts “Jane,” “Rouge,” “Jeanie,” and “JimmyC” are contacts of second level lower contact “Louise.” Additional level lower contacts (e.g. fourth level, fifth level, sixth level, etc.) can also be included in the multi-level directory contact window 686. One should also note that generally speaking, second level, third level, etc. lower contacts (collectively referred to herein as “indirect lower contacts”) can be displayed when the chain of lower contacts leading back to the user is unbroken. More specifically, in order to display third level lower contacts 680, second level lower contact “Louise” and first level lower contact “Leigh” can both be present. Similarly, because first level lower contact “Andrew” is not present, Andrew's lower contacts are not displayed.

Also included in multi-level directory contact window 686 is a “save” option 676 and a “show info” option 682. The “save” option 676 can provide the first user with an option to save any of the indirect lower contacts as a first level contact (where the term “indirect” lower contacts refers to lower contacts that are second level or lower and the “direct” lower contacts refer to the first level user contacts). More specifically, because third level lower contact “Jane” is generally not displayed unless both Leigh and Louise are present, the first user may desire to make Jane a first level lower contact. By selecting “Jane” and the “save” option, Jane can be made a first level lower contact (either by addition as a contact through a menu, or by way of drag-and-drop), and displayed irrespective of the presence of other contacts. While in some embodiments, a link to an account of the contact can be saved, other embodiments can include an option to save additional information related to the contact (such as an email address, IM address, home address, phone number, etc.).

The “show info” option 682, on the other hand, allows the first user to view various sets of information related to the contacts displayed in multi-level directory contact window 686. More specifically, the multi-level directory contact window 686 includes a first name of the contacts listed therein. By selecting the desired contact, an instant message (or other communication request, depending on the configuration) can be sent to that contact. However, other information may also be desirable. By selecting a contact and the “show info” option 682, the user can view other information related to the selected contact. The displayed information can include full name, address, email address, instant messaging address, telephone number, website, etc. Additionally, as discussed in more detail below, information related to contacts can be restricted to certain parties, depending on the desired configuration.

FIG. 7 is a display of an exemplary instant messaging window, illustrating contacts from a plurality of sources, similar to the configuration from FIG. 6. More specifically, instant messaging window 770 includes an input prompt 784 from where the first user can send and receive messages. Also included is a “DISPLAY” option 794, an “OPTIONS” option 788, a “CONTACTS” option 790, and a “SEND” option 792. Also included is a linear multi-level directory contact window 786. The linear multi-level directory contact window 786 can include the same contacts as the multi-level directory contact window 686, however, in this nonlimiting example the relationship of the contacts is not displayed. As some users may not want to see the relationship of each contact, the display of FIG. 7 provides only the desired information. As the direct and indirect lower contacts 784 are displayed on the left, a presence icon 796 is displayed next to those contacts that are currently logged onto the server 102. Additionally, a “show info” option 798 is displayed that can provide the first user with the option to view information related to the selected contact, as described above. A “relationship” option 799 can provide, information related to the relationship of the selected contact to the user. The view of the relationship information may be expandable, and the depth or level at which the relationships are viewable may depend on viewing restrictions.

FIG. 8 is a display of an exemplary options window for providing a user with the ability to determine how his or her information is displayed to other users, similar to the display of FIG. 6. More specifically, in response to selecting the “OPTIONS” option provided in instant messaging window 670, the first user can be provided with a “my information” window 870. The “my information” window 870 can include a “degrees of separation” option 894, which can provide the first user with the ability to determine how many levels the first user desires his or her information to be propagated. More specifically, by selecting “Three” from the “degrees of separation” option 894, the user is designating that his or her information will be displayed no deeper than as a level three contact to other parties. If the first user desires that his or her information not be displayed as a contact, he or she can select “zero.”

Additionally included in the “my information” window 870 is a “provide information” option 896. The “provide information” option 896 allows the first user to determine who receives the first user's contact information. If the first user desires that his or her information be provided to all parties with access to the first user's account, the first user can select “to all with access.” Alternatively, if the first user wishes that nobody receive any information related to the first user's contact information, the first user can select the “no one” option. If the first user wishes to more specifically determine which parties are provided with information, the first user can select the “let me choose option,” which can facilitate display of another window for the first user to determine the information provided to different other parties.

An additional option provided in the “my information” window 870 is a “provide information type” option 898, which can provide the first user the ability to determine the type of information displayed to other parties. More specifically, if the first user desires that other parties only have access to a link to the user's communications accounts (instant messaging, email, Internet telephony, etc.), the first user can select the “access only” option. If the first user desires that other parties be provided with all contact information related to the first user, the first user can select the “all information” option. If, on the other hand, the first user wishes to more specifically define the amount of information provided to other parties, the first user can select the “let me choose option.” The first user can select the “save settings” option 880 to save the current selections.

FIG. 9 is a display of an exemplary interface to a “my contacts' information” option that can be provided to a user of the instant messaging software from FIG. 6. More specifically, upon selecting the “CONTACTS” option 690 from FIG. 6, the first user can be provided with “my contacts' information” window 970. The “my contacts' information” window 970 can include a “provide information” option 996, which can allow the first user to limit communication of the first user's contacts' information to others. By selecting the “to all with access” option, the first user can designate that anyone with access to the first user's contacts' information be provided with that information. If the first user selects the “only to first level” option, information about the first user's contacts is only provided to those who list first user as a first level contact (direct upper contacts). As the first user may only trust those who consider first user a contact, the first user may want restrict communication of this information to anyone beyond the first level. If, on the other hand, the first user selects the “let me choose” option, the first user can manually designate those people who are granted access to information related to the first user's lower contacts.

Additionally provided in the “my contacts' information” window 970 is a “provide information type” option 998. Similar to the “provide information type” option 898 from FIG. 8, the “provide information type” option 998 provides the first user with the ability to determine the type of information provided to other parties. More specifically, the first user can determine whether information is provided to others, or whether a link is provided. The difference between the “provide information type” option 998 and the “provide information type” option 898 from FIG. 8 is that here, the information is related to the first user's contacts, and not to information about the first user. A save settings option 980 may also be provided.

FIG. 10 is a display of an exemplary interface to a “my display” option that a can be provided to a user, from the instant messaging window from FIG. 6. More specifically, by selecting the “DISPLAY” option 694 in the instant messaging window 670 from FIG. 6, the first user can be provided with a “my display” window 1070. The “my display” window 1070 can include a “degrees of separation” option 1092 that can determine how may levels of contacts the communications software 399 will display. While a party may have access to the maximum number of allotted levels, the first user may only wish that a subset of those levels be displayed. Additionally included in the “my display” window 1070 is a “save as my contact” option 1094. This option can provide the user with a way to automatically save indirect lower contacts as first level (direct) lower contacts. Alternatively, by selecting the “let me choose” option, the first user can be provided with an option to save contact information upon being presented with a new indirect lower contact.

Additionally, the “my display” window 1070 provides the first user with the ability to automatically save the information related to indirect lower contacts. Depending on the access granted to the first user regarding a contact's information (as discussed above), the “save information” option can provide that the first user only save the access information (a link), all information, or allow the first user to determine the desired information on a case-by-case basis.

An additional option provided in the “my display” window 1070 is a “display information” option 1098. The “display information” option 1092 can allow the first user to automatically view contact information for each contact displayed in multi-level directory contact window 686. If the first user desires that only information related to certain contacts be displayed, the first user can select the “let me choose” option. Additionally included in the “my display” window 1070 is a save settings option 1080.

FIG. 11 is a flowchart illustrating exemplary steps that can be taken in providing contact information related to a user as in a communications environment, such as the environment from FIG. 1. The first step in this nonlimiting example is to log onto the server (block 1130). As described above, a user can log onto an instant messaging server, email server, or other type of server for access to various communication services provided by that server. Included in the login process is an authentication process, which can include a USERID and password or the user of one or more biometric authentication processes (or both). Next, the user's communications software 399 can receive a request from the user regarding contact information (block 1132). The request can include the user opening the communications software 399, or other input to access information related to the user's contacts. Next, the communications software 399 can determine whether the user is permitted to receive the requested information (block 1134). More specifically, upon attempting to access the user's contacts, the communications software can determine which contacts are present. Of the present contacts, the communications software 399 can determine indirect lower contacts. Next, the communications software 399 can determine which information the user is permitted to receive (block 1136). As discussed above, various settings determined by each party involved can determine the information provided to the user. Once the information is determined, the communications software 399 can communicate to the user information related to the contacts (block 1138).

FIG. 12 is a flowchart illustrating exemplary steps that can be taken in determining information displayed in a communications environment, such as the communications environment from FIG. 1. The first step in the flowchart of FIG. 12 is to log the user onto the server (block 1230). Next, the communications software 399 sets “Level” (L)=1 (block 1232). This indicates that the actions are performed on first level contacts. Next, the communications software 399 determines the presence of “L” level contacts. As discussed above, generally speaking, indirect lower contacts can be displayed when the chain of contacts before them is not broken. This means that in determining the indirect lower contacts, the communications software 399 can determine the presence of the first level (direct) lower contacts.

A determination is then made whether “Level” is less than or equal to “Maximum” (block 1236). “Maximum” represents the maximum levels of contacts that a server (or user) will allow. As providing multiple levels of contacts can increase network activity, a network administrator may desire that only a predetermined number of levels of contacts be provided to any user. Next, the communications software 399 can increase “L” by one (block 1238). Then, the communications software 399 can provide that for each (L−1) level contact (previous lower contact) that is present, determine L level contacts (block 1240). As a nonlimiting example, this step indicates that for each first level contact that is present, the communications software 399 will determine the second level contacts. As an additional nonlimiting example, for all the second level contacts that are present, the communications software 399 will determine the third level contacts. This step illustrates that in some embodiments, the indirect lower contacts are determined based one level at a time. More specifically, the first level contacts are determined, then the second level contacts, then the third level contacts, and so on.

The next step in the flowchart of FIG. 12 is to determine (block 1242) the presence of each L level contact. The flowchart then returns back to block 1236 to determine whether L is less than or equal to “Maximum.” If L is less than or equal to “Maximum,” the process will continue until all levels are determined. If, on the other hand, L is greater than “Maximum,” the flowchart will end, and the contacts can be displayed to the user.

One should note that while the steps discussed with respect to FIG. 12 are directed to communications software 399, this is a nonlimiting example. More specifically one or more of these steps can be performed on server 102 or elsewhere. Similarly, server 102 can include communications software 399 to facilitate performance of the steps described.

FIG. 13 is flowchart illustrating exemplary steps that can be taken to determine multi-level contacts, similar to the flowchart from FIG. 12. The first step in the flowchart of FIG. 13 is to log the user onto the server (block 1330). Next, the communications software 399 can determine the first level contacts (block 1332). Next, the communications software 399 can determine the presence of the first level contacts (block 1334). As described above, presence icons can also be determined. Once the first level contacts are determined, and their current presence status is identified, the communications software 399 can, for the present first level contact “X,” determine the second level contacts (block 1336). The communications software can then determine the presence of the second level contacts (block 1338).

Once the presence of the second level contacts is determined, the communications software 399 can determine the “N−1” level contacts for the second level contact “Y.” (block 1340). This process can continue to determine the presence of the “N−1” level contacts associated with the present previous level contact (block 1356). Once, the presence is determined, the “N” level contacts for the present “N−1” level contact can be determined (block 1354).

Once the “N” level contacts are determined for that N−1 level contact, in block 1354, a determination is made as to whether “N” is greater than or equal to “Max N” (block 1350) where “Max N” can be the total number of “N” level contacts in that branch. If “N” is not greater than or equal to “Max N,” “N” can be incremented by one (block 1352) and the “N” level contacts can be determined for the next N−1 level contact (block 1354). When the “N−1” level contacts are exhausted, the flowchart will determine (block 1350) that “N” is now greater than or equal to “Max N,” and the flowchart can proceed to determination block 1342.

The flowchart then can determine whether Y is greater than “Max Y,” where “Max Y” can be the total number of second level contacts. If the flowchart determines that Y is not greater than “Max Y,” the flowchart increments Y by 1 (block 1344), and repeats the step in block 1340. When the present second level lower contacts associated with X first level contact have been determined, the flowchart will conclude that Y is greater than or equal to “Max Y,” and the flowchart will proceed to block 1348, where a determination is made as to whether X is greater than “Max X.”

Here, “X” can be the total number of first level contacts. If X is not greater than or equal to “Max X,” X is incremented by 1 (block 1346) and the flowchart returns to block 1336. When the first level contacts have been exhausted, the flowchart can determine that X is greater than or equal to “Max X” and the flowchart will end. The communications software can then display the contacts. This process can continue until all lower level contacts are exhausted.

In an illustrative example, referring back to FIG. 6, the communications software 399 can determine the first level contacts 672 (block 1332). As stated above, these contacts can be stored on the user's client device or on a server 102. Next, the software can determine the presence of the first level contacts (block 1334). As illustrated in FIG. 6, “Leigh” and “Rebecca” are the only first level contacts that are currently present. Next, the communications software can determine the second level contacts that are associated with “Leigh” (block 1336). As illustrated in FIG. 6, “Leigh” has contacts (which are second level contacts of the user) “Joey,” “Louise,” “Joy,” “Judy,” and “Emily.”

Next, the communications software 399 determines the presence of the second level contacts (block 1338). As illustrated, the only present second level contact is “Louise.” The flowchart then determines the third level contacts that are associated with “Louise” (block 1340). “Louise's” contacts “Jane,” “Rouge,” “Jeanie,” and “JimmyC” are then determined. The flowchart then determines whether all of the present second level contacts have been identified (block 1342). If not, the flowchart proceeds to the next second level contact (blocks 1344, 1340). In the example of FIG. 6, there are no more present second level contacts associated with “Leigh,” so the flowchart proceeds to block 1348 to determine whether there are any other first level contacts who are present (blocks 1346, 1336).

In the nonlimiting example of FIG. 6, first level contact “Rebecca” is present and is associated with second level contacts “JimmyT,” “Allan,” “Patty,” and “John.” As none of these contacts are present, the flowchart bypasses block 1340. Similarly, since there are no more present contacts, the process can end, and the multi-level directory can be displayed in window 686.

One should note that the logic described with respect to FIG. 13 includes “N” levels of contacts. As discussed above, any number of levels can be implemented, with similar logic being employed. Additionally, the flowchart of FIG. 13 describes determining multi-level contacts one branch at a time, while the flowchart of FIG. 12 describes determining multi-level contacts one level at a time. While any type of logic can be employed, these are described for illustration.

Additionally, while the steps discussed with respect to FIG. 12 are directed to communications software 399, this is a nonlimiting example. More specifically, one or more of these steps can be performed on server 102 or elsewhere. Similarly, server 102 can include communications software 399 to facilitate performance of the steps described.

One should also note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for providing contact information, the method comprising:
determining at least one direct contact of the user, wherein the at least one direct contact is associated with contact information;
determining presence information related to the at least one direct contact of the user; and
in response to determining presence information related to the at least one direct contact of the user, determining at least one indirect contact of the user, wherein the at least one indirect contact is associated with contact information, wherein the at least one indirect contact is a contact of the at least one direct contact of the user, and wherein the at least one indirect contact is different than the at least one direct contact.

2. The method of claim 1, further comprising determining the presence of the at least one indirect contact of the user.

3. The method of claim 1, further comprising facilitating display of at least a portion of the contact information associated with the at least one indirect contact.

4. The method of claim 1, further comprising providing an option to save a link to the at least one indirect contact.

5. The method of claim 1, further comprising providing an option to save at least a portion of the contact information associated with the at least one indirect contact.

6. The method of claim 1, wherein the at least one indirect contact is a direct contact of the at least one direct contact.

7. The method of claim 1, wherein the at least one indirect contact is at least one of the following: a second level contact of the user, a third level contact of the user, a fourth level contact of the user, a fifth level contact of the user, and a sixth level contact of the user.

8. A computer readable medium that includes a program for providing contact information, the program comprising:
logic configured to determine at least one direct contact of the user, wherein the at least one direct contact is associated with contact information;
logic configured to determine presence information related to the at least one direct contact of the user; and
logic configured to, in response to determining presence information related to the at least one direct contact of the user, determine at least one indirect contact of the user, wherein the at least one indirect contact is associated with contact information, wherein the at least one indirect contact is a contact of the at least one direct contact of the user, and wherein the at least one indirect contact is different than the at least one direct contact.

9. The computer readable medium of claim 8, the program further comprising logic configured to facilitate display of at least a portion of the contact information associated with the at least one indirect contact.

10. The computer readable medium of claim 8, the program further comprising logic configured to determine the presence of the at least one indirect contact of the user.

11. The computer readable medium of claim 8, the program further comprising logic configured to facilitate display of a relationship between the at least one indirect contact with the user.

12. The computer readable medium of claim 8, the program further comprising logic configured to provide an option to save a link to the at least one indirect contact.

13. The computer readable medium of claim 8, the program further comprising logic configured to provide an option to save at least a portion of the contact information associated with the at least one indirect contact.

14. The computer readable medium of claim 8, the program wherein the at least one indirect contact is a direct contact of the at least one direct contact.

15. The computer readable medium of claim 8, wherein the at least one indirect contact is at least one of the following: a second level contact of the user, a third level contact of the user, a fourth level contact of the user, a fifth level contact of the user, and a sixth level contact of the user.

16. A method for providing a user with contact information, the method comprising:
determining information related to at least one first level contact of the user, wherein the at least one first level contact is associated with user information, wherein the first level contact is associated with contact information;
determining, from the contact information related to the at least one first level contact, at least one second level contact of the user, wherein the at least one second level contact of the user is associated with user information, wherein the at least one second level contact is associated with contact information;
facilitating display of at least a portion of the user information associated with the at least one first level contact; and
facilitating display of at least a portion of the user information associated with the at least one second level contact.

17. The method of claim 16, further comprising determining, from the contact information related to the at least one second level contact, at least one other level contact, wherein the at least one other level contact is different than the at least one second level contact, wherein the at least one other level contact is different than the at least one first level contact.

18. The method of claim 17, wherein the at least one other level contact included at least one of the following: a third level contact of the user, a fourth level contact of the user, a fifth level contact of the user, a sixth level contact of the user, and a seventh level contact.

19. The method of claim 16, further comprising at least one of the following: determining presence information related to the at least one first level contact and determining presence information related to the at least one second level contact.

20. The method of claim 16, further comprising providing an option to save at least a portion of the contact information associated with the at least one second level contact.
